(19) United States
(12) Patent Application Publication
(10) Pub. No.: US 2010/0315464 A1
(43) Pub. Date: Dec. 16, 2010

(54) AEROSOL CLEARING APPARATUS OF INKJET PRINTER

(75) Inventor: Sheng-Chang Wu, Taipei County (TW)

Correspondence Address: J C PATENTS, 4 VENTURE, SUITE 250, IRVINE, CA, 92618, US

(73) Assignee: KINPO ELECTRONICS, INC., Taipei County (TW)

(21) Appl. No.: 12/509,618

(22) Filed: Jul. 27, 2009

(30) Foreign Application Priority Data
Jun. 12, 2009 (TW) 98119735

(51) Int. Cl. B41J 2/165

(52) U.S. Cl. 347/34

(57) ABSTRACT

An aerosol clearing apparatus of an inkjet printer is provided. The aerosol clearing apparatus includes a plastic strip fastened on the housing of the inkjet printer, and a friction element which has a cloth material friction element and is disposed on a carriage in the inkjet printer. When the carriage moves, the friction element moves correspondingly and rubs the cloth material friction element against the plastic strip, so as to generate static electricity to absorb aerosol generated by a pen.

### CROSS-REFERENCE TO RELATED APPLICATION

This application claims the priority benefit of Taiwan application serial no. 98119735, filed on Jun. 12, 2009. The entirety of the above-mentioned patent application is hereby incorporated by reference herein and made a part of specification.

### BACKGROUND OF THE INVENTION

1. Field of the Invention

The present invention relates to an aerosol clearing apparatus of a printer and particularly relates to an aerosol clearing apparatus which utilizes static electricity to absorb aerosol in a printer.

2. Description of Related Art

As the price of inkjet printer is becoming lower and the quality of printing is getting higher, inkjet printer gradually becomes an electric product indispensable to people and their family. When it comes to photo printing, inkjet printers can output high-quality photos and color/black-and-while documents having real and vivid color as photo shops can produce. Moreover, due to the decreasing price, color inkjet printers have become necessary computer-related products in every family.

In view of an inkjet printer, when the printer sprays ink for printing, aerosol occurs. Aerosol randomly attaches to the inside of the printer, such as the surface of the printed circuit board assembly (PCA) and mechanical/electronic elements. When aerosol adheres onto important electronic judgment elements such as encoder strip or encoder sensor for sensing the encoder strip, the sensing of the printer may malfunction.

### SUMMARY OF THE INVENTION

In view of the aforementioned defects, the present invention provides an aerosol clearing apparatus that rubs plastic against cloth material to generate static electricity, thereby absorbing the aerosol which occurs during printing on a plastic strip, so as to prevent the aerosol from adhering onto a sensing element (such as encoder sensor) and influencing the function of the printer.

Based on the above, the present invention provides an aerosol clearing apparatus for an inkjet printer. The printer includes a carriage and transmission means disposed therein. The carriage carries an ink cartridge, and the transmission means is connected with the carriage to move the carriage along a path. Moreover, the aerosol clearing apparatus includes a plastic strip and a friction element. The plastic strip is fastened on a housing of the printer and disposed at a side of the carriage. The friction element is disposed at one side of the carriage and includes a cloth material friction element in contact with the plastic strip. The friction element moves with the carriage to rub the cloth material friction element against the plastic strip.

The friction element is shaped as inverted L or inverted U. When the friction element is shaped as inverted L, the friction element includes a top portion, a first sidewall portion, and a first connection structure. The top portion has a first inner side, and the first sidewall portion has a second inner side. The first connection structure is disposed at one side of the top portion to connect a second connection structure disposed on a back portion of the carriage. Specifically, the first inner side and the second inner side constitute a containing portion. The cloth material friction element is disposed on at least one of the first inner side and the second inner side of the friction element and corresponds to a side of the plastic strip. Herein, the first connection structure can be a latch structure.

Moreover, the friction element can include an additional sidewall to form an inverted-U structure, and the containing portion of the friction element is formed by three inner sides. The cloth material friction element can be disposed on at least one of the three inner sides of the friction element.

In an embodiment of the present invention, the transmission means includes a stepping motor, a belt wheel, a passive wheel, and a belt. The stepping motor drives the belt wheel to rotate, and through the belt, rotates the passive wheel. The carriage is connected to the belt and driven by the belt to move along the path. Furthermore, the inkjet printer includes an encoder strip fixed on the housing of the printer, wherein the plastic strip is disposed under the encoder strip.

Based on the above descriptions of the present invention, the carriage has the friction element disposed thereon, and the plastic strip is equipped inside the printer. As the carriage moves during printing, the friction element is rubbed against the plastic strip to generate static electricity, which absorbs aerosol, thereby preventing the aerosol from adhering onto the optical sensing element of the printer and influencing the function of the printer.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram depicting a part of the structure inside a printer according to an embodiment of the present invention.

FIG. 2A is a schematic diagram depicting the structures of a friction element and a carriage according to the first embodiment of the present invention.

FIG. 2B is a schematic diagram showing the structure of a friction element 210 according to the first embodiment of the present invention.

FIG. 3A is a schematic diagram depicting the structures of a friction element and a carriage according to the second embodiment of the present invention.

FIG. 3B illustrates a friction element 310 shaped as an inverted U according to the second embodiment of the present invention.

FIG. 4 is a schematic diagram illustrating an inkjet printer according to an embodiment of the present invention.

### DESCRIPTION OF EMBODIMENTS

### First Embodiment

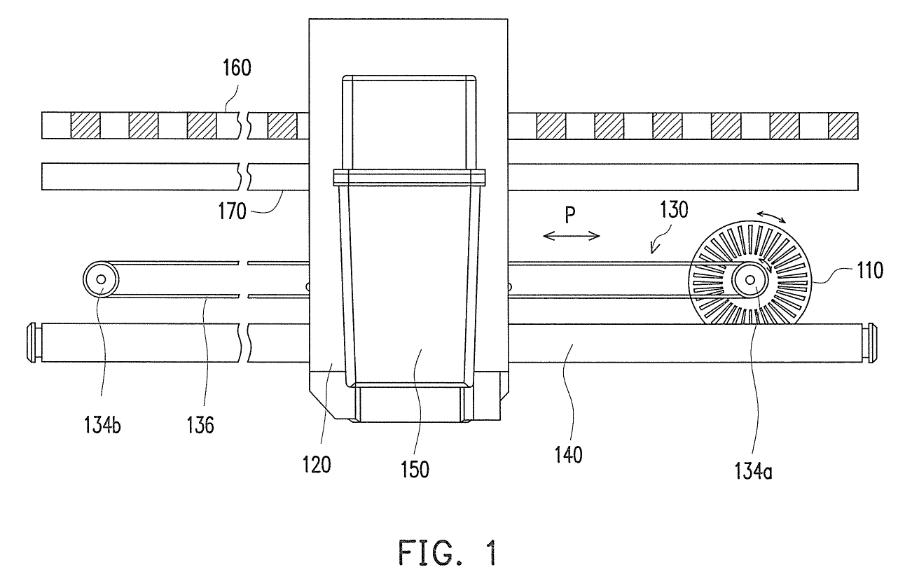

Referring to FIG. 1, FIG. 1 is a schematic diagram depicting a part of the structure inside a printer according to an embodiment of the present invention, wherein the printer includes transmission means 130, a shaft 140, a carriage 120, an encoder strip 160, and a plastic strip 170. The carriage 120 is slidably disposed on the shaft 140. The transmission means 130 is connected to the carriage 120 to move the carriage 120 along a path P. An ink cartridge 150 is detachably disposed on the carriage 120 and moves with the carriage 120 for printing. The transmission means 130 includes a stepping motor 110, a belt wheel 134a, a passive wheel 134b, and a belt 136, wherein the stepping motor 110 rotates the belt wheel 134a to forward the belt 136, and the carriage 120 is connected to the belt 136 and driven by the belt 136 to move along the path P.

The encoder strip 160 is fixed on a housing (not shown) of the printer and disposed behind the carriage 120. The encoder strip 160 is a plastic plate, formed of staggered transparent and opaque optical fences, to coordinate with an optical encoder to react to the encoder strip 160, thereby providing a signal to position the carriage 120. The plastic strip 170 is fastened on the housing of the printer. Moreover, the plastic strip 170 is disposed behind the carriage 120 and under the encoder strip 160.

One friction element (not shown) is disposed at one side (close to the plastic strip 170) of the carriage 120. The friction element includes a cloth material friction element that is in contact with the plastic strip 170. The friction element moves with the carriage 120 to rub the cloth material friction element against the plastic strip 170, so as to generate static electricity in the plastic strip 170 for absorbing aerosol. As the carriage 120 moves along the path P, the friction element and the plastic strip 170 behind the carriage 120 generates static electricity for absorbing aerosol. The aerosol absorbed on the plastic strip 170 is brushed to two ends of the plastic strip 170 due to the movement of the friction element, which prevents the aerosol from adhering onto the encoder strip 160 or the sensing element of the optical encoder.

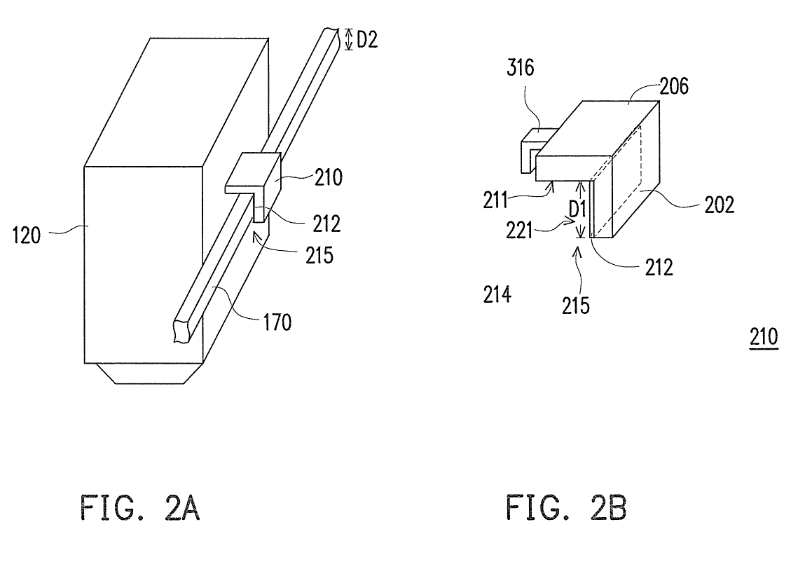

Please refer to FIG. 2A for a position of the friction element. FIG. 2A is a schematic diagram showing the structures of the friction element and the carriage according to the first embodiment of the present invention, wherein the friction element 210 is fixed on the carriage 120 and has a containing portion 215 that is open for fitting the plastic strip 170. The cloth material friction element 212 is disposed on an inner sidewall of the containing portion 215 to be in contact with the plastic strip 170. One of the functions of the cloth material friction element 212 is to rub against the plastic strip 170 for generating static electricity when the carriage 120 is moving. Please refer to FIG. 2B for a structure of the friction element 210 in this embodiment. FIG. 2B is a schematic diagram showing the structure of the friction element 210 according to the first embodiment of the present invention. The friction element 210 includes a latch portion 316 for being fixed on the carriage 120. Specifically, the friction element 210 has a top portion 206 and a first sidewall portion 202. The top portion 206 has a first inner side 211 and the first sidewall portion 202 has a second inner side 221 for forming a containing portion 215. The plastic strip 170 can be fitted into the containing portion 215 of the friction element 210 to lean against the second inner side 221 of the friction element 210.

The second inner side 221 has the cloth material friction element 212 disposed thereon, which is to be rubbed against the plastic strip 170 for generating static electricity. Likewise, the first inner side 211 can also have another cloth material friction element 212 thereon for increasing a contact area of the friction element 210 and the plastic strip 170 and enhancing the static electricity. It is noted that this embodiment does not limit the shape and material of the cloth material friction element 212 used in the present invention. Any material that can be rubbed with the plastic strip 170 to generate static electricity can be used. The material is preferably cloth or paper, but the present invention is not limited thereto. In addition, the cloth material friction element 212 can also be disposed on a back portion of the carriage 120, corresponding to the position of the friction element 210, to increase the contact area of the cloth material friction element 212 and the plastic strip 170. Moreover, to enhance a rubbing efficiency of the cloth material friction element 212 and the plastic strip 170, the cloth material friction element 212 can also have patterns formed thereon to increase static electricity. In this embodiment, to increase a rubbing area of the friction element 210 and the plastic strip 170, a height D1 (as shown in FIG. 2B) of the second inner side 221 is equal to or larger than a height D2 (as shown in FIG. 2A) of the plastic strip 170.

In addition, the friction element 210 and the carriage 120 can be connected by latching. The latch portion 316 mainly functions to connect the friction element 210 with the carriage 120 and has a connection structure, such as a latching hook or tenon, which fits a corresponding fixing structure, such as a slot, disposed on the carriage 120. This embodiment does not limit the type of the latch portion that is used for the present invention. Besides the above, the friction element 210 and the carriage 120 can also be connected by Nylon fasteners, screws, adhesive, or buttons. This embodiment does not limit the methods of connecting the friction element 210 with the carriage 120.

It should be noted that the structure of the friction element 210 is not limited to the disclosure of FIG. 2B. The friction element 210 can have a different structure, as long as the different structure allows the plastic strip 170 to pass therethrough and rubs the plastic strip 170 to generate static electricity as the carriage 120 moves. A material of the cloth material friction elements 212 and 214 is a capillary material or a capillary cloth of Nylon fastener. This embodiment does not limit the material that is used as the cloth material friction element. Any material that can be rubbed against the plastic strip 170 to generate static electricity can serve as the cloth material friction element. Moreover, the plastic strip 170 is also shaped as a plate to increase the rubbing area for enhancing static electricity.

### Second Embodiment

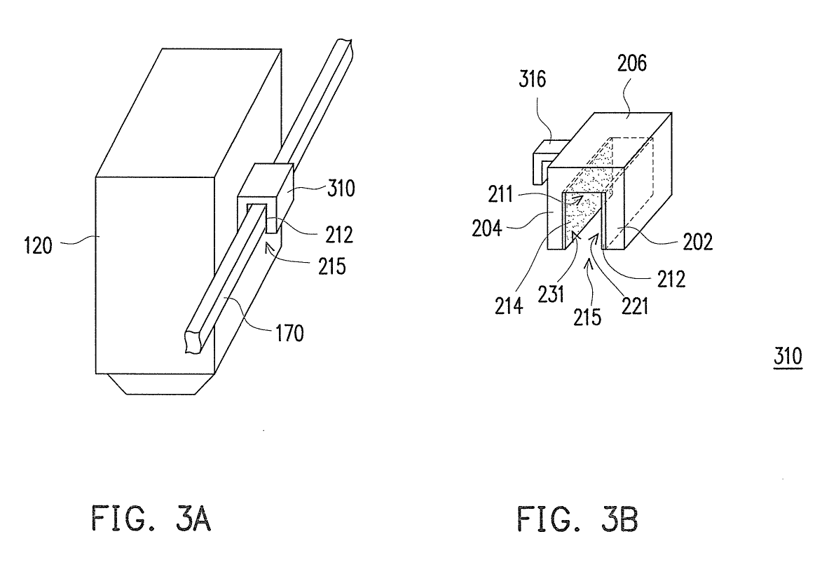

The friction element of the present invention is not limited to the inverted L shape, as shown in FIG. 2B. The friction element is also shaped as an inverted U or a semicircle, which has an opening structure. Please refer to FIGS. 3A and 3B. FIG. 3A is a schematic diagram illustrating the structures of a friction element and a carriage according to the second embodiment of the present invention, wherein a friction element 310 is shaped as an inverted U. FIG. 3B is a schematic diagram showing the structure of the friction element according to the second embodiment of the present invention. FIG. 3B illustrates the friction element 310 shaped as inverted U. The friction element 310 includes the first sidewall portion 202, the second sidewall portion 204, and the top portion 206, which form the containing portion 215 that has an inverted-U shape. The friction element 310 and the friction element 210 are basically different in the second sidewall portion 204. In particular, cloth material friction elements 212 and 214 are respectively disposed on the inner sides 221 and 231 of the first sidewall portion 202 and the second sidewall portion 204. In addition, the inner side 211 of the top portion 206 of the containing portion 215 also has another cloth material friction element disposed thereon to increase the contact area of the friction element 310 and the plastic strip 170. It should be noted that the cloth material friction element can be selectively disposed on any inner side of the containing portion 215. This embodiment does not limit the positions for disposing the cloth material friction element.

Moreover, the structure of the friction element is not limited to the disclosures of FIGS. 2A˜3B. The friction element can be any kind of opening structure, as long as the opening structure allows the plastic strip 470 to pass therethrough and rubs the plastic strip 470 to generate static electricity as the carriage 120 moves. The shapes of the containing portions 215 and 315 are not limited to the disclosures of FIGS. 2A˜3B. The containing portions 215 and 315 can have any kind of opening shape, as long as the opening shape can contain the plastic strip 170 therein and allow the plastic strip 170 to lean against the inner sides of the friction elements 210 and 310. The opening of the friction element is not limited to be upward or downward, and the opening can be in any direction as long as the opening can have the plastic strip 170 disposed therein. This embodiment does not limit the shape and the direction of opening of the containing portions 215 and 315. A material of the cloth material friction element 412 is a capillary material or a capillary cloth of Nylon fastener. This embodiment does not limit the material that is used as the cloth material friction element. Any material that can be rubbed against the plastic strip 170 to generate static electricity can serve as the cloth material friction element. Moreover, the plastic strip 470 is also shaped as a plate to increase the rubbing area for enhancing static electricity.

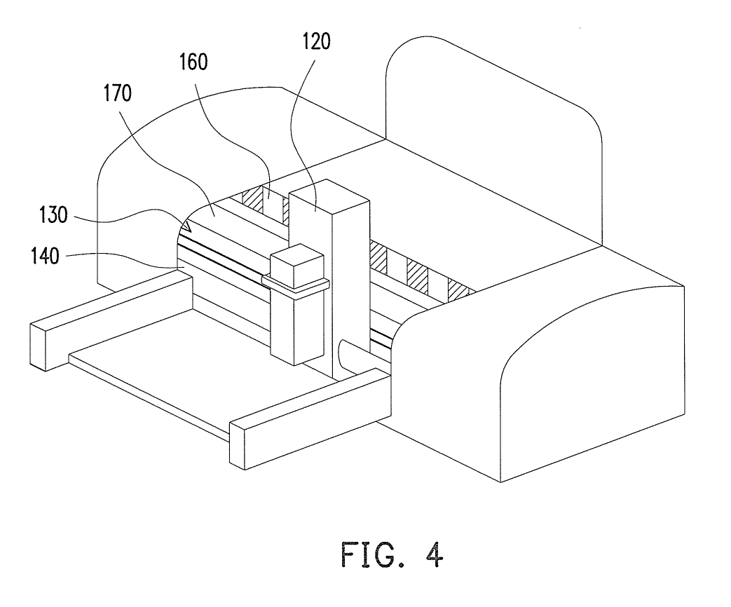

Thereafter, please refer to FIGS. 1, 2A, and 4. FIG. 4 is a schematic diagram of an inkjet printer according to one embodiment of the present invention, wherein the plastic strip 170 is disposed underneath the encoder strip 160 and is rubbed to generate static electricity for absorbing aerosol as the carriage 120 moves. In addition, during the movement of the carriage 120, the cloth material friction element 212 of the friction element 210 brushes the aerosol absorbed on the plastic strip 170 to two ends of the plastic strip 170. The vibration that occurs when the inkjet printer drives the carriage 120 shakes the aerosol accumulating on the two ends of the plastic strip 170 off to a collecting device or a collecting area, so as to prevent the aerosol from affecting the electric or optical parts in the inkjet printer and causing malfunction. More specifically, the collecting device is located under the two ends of the plastic strip 170 or the collecting area is disposed in the housing of the inkjet printer for collecting the fallen aerosol.

The plastic strip 170 is disposed according to the original structure of the inkjet printer and the transmission structure of the carriage 120. Therefore, the plastic strip 170 does not influence the transmission of the carriage 120 and requires no additional transmission means. By utilizing the plastic strip 170 and the friction element 210 on the back portion of the carriage 120, the present invention achieves the effect of clearing aerosol when the inkjet printer performs printing.

In conclusion, the present invention is directed to disposing the plastic strip and the friction element in the inkjet printer. When the carriage moves, the friction element is moved to rub the plastic strip to generate static electricity for absorbing aerosol. Consequently, the aerosol is kept from adhering onto electric elements, such as encoder strip or optical sensor. The influence that the aerosol causes to the inkjet printer is prevented.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An aerosol clearing apparatus for an inkjet printer, wherein the inkjet printer comprises therein a carriage carrying an ink cartridge and transmission means connected with the carriage to move the carriage along a path, the aerosol clearing apparatus comprising:
a plastic strip fastened on a housing of the printer and disposed at a side of the carriage; and
a friction element disposed at one side of the carriage, and the friction element comprising a cloth material friction element in contact with the plastic strip, wherein the friction element moves with the carriage to rub the cloth material friction element against the plastic strip.

2. The aerosol clearing apparatus as claimed in claim 1, wherein the friction element comprises:
a top portion having a first inner side;
a first sidewall portion having a second inner side, and the first sidewall portion being connected to the top portion; and
a first connection structure disposed at a side of the top portion to connect a second connection structure disposed on a back portion of the carriage;
wherein the first inner side and the second inner side constitute a containing portion, the plastic strip is fitted into the containing portion, and the cloth material friction element is disposed on at least one of the first inner side and the second inner side of the friction element.

3. The aerosol clearing apparatus as claimed in claim 2, wherein the first connection structure is a latch structure.

4. The aerosol clearing apparatus as claimed in claim 2, wherein the friction element is shaped as an inverted L.

5. The aerosol clearing apparatus as claimed in claim 1, wherein the friction element comprises:
a top portion having a first inner side;
a first sidewall portion having a second inner side;
a second sidewall portion having a third inner side; and
a first connection structure disposed at a side of the top portion to connect a second connection structure disposed on a back portion of the carriage;
wherein the top portion is connected with the first sidewall portion and the second sidewall portion; the first inner side, the second inner side, and the third inner side constitute a containing portion; the plastic strip is fitted into the containing portion; and the cloth material friction element is disposed on at least one of the first inner side, the second inner side, and the third inner side of the friction element.

6. The aerosol clearing apparatus as claimed in claim 2, wherein the first connection structure is a latch structure and the second connection structure is a slot.

7. The aerosol clearing apparatus as claimed in claim 5, wherein the friction element is shaped as an inverted U.

8. The aerosol clearing apparatus as claimed in claim 1, wherein the transmission means comprises a stepping motor, a belt wheel, a passive wheel, and a belt; the stepping motor drives the belt wheel to rotate and, through the belt, rotates the passive wheel; and the carriage is connected with the belt and driven by the belt to move along the path.

9. The aerosol clearing apparatus as claimed in claim 1, wherein the printer comprises an encoder strip fixed on the housing of the inkjet printer, and the plastic strip is disposed at a side of the encoder strip.
